(19) United States
(12) Patent Application Publication
(10) Pub. No.: US 2008/0127783 A1
(43) Pub. Date: Jun. 5, 2008

(54) TOOL DRIVER WITH REVERSIBLE HANDLE

(75) Inventor: Jake Wadsworth, St. Ignatius, MT (US)

Correspondence Address: Fellers, Snider, Blankenship, Bailey & Tippens P.C;Suite 1700, 100 North Broadway, Oklahoma City, OK, 73102-8820, US

(73) Assignee: Professional Tool Manufacturing, LLC, Ashland, OR (US)

(21) Appl. No.: 11/970,651

(22) Filed: Jan. 8, 2008

Related U.S. Application Data
(63) Continuation-in-part of application No. 29/253,376, filed on Feb. 6, 2006.

(51) Int. Cl. B25B 23/16

(52) U.S. Cl. 81/177.8

(57) ABSTRACT

Apparatus for engaging a mechanical component, such as a fastener. The apparatus includes a handle, and an elongated shank with opposing proximal and distal ends. The distal end supports a tool driver. The proximal end is pivotally coupled to a location offset from a midline of the handle to facilitate alignment of the shank along the handle in pivotally opposite extended and shortened positions, respectively. In the extended position, the tool driver projects a first distance beyond a first end of the handle. In the shortened position, the tool driver projects beyond an opposing second end of the handle a second distance less than the first distance.

### RELATED APPLICATIONS

The present application is a continuation-in-part (CIP) of co-pending U.S. Design patent application Ser. No. 29/253,376 filed Feb. 6, 2006.

### BACKGROUND

Tools are used in a variety of applications to engage mechanical components, such as fasteners. A variety of fastener driver configurations are well known in the art, such as flat and cross-head screwdriver patterns, socket heads, hex key wrench channels, etc. Such tools can be commercially supplied individually, or as a set to cover a variety of sizes and lengths.

### SUMMARY

Various embodiments of the present invention are generally directed to an apparatus for engaging a mechanical component, such as a fastener.

In accordance with some embodiments, the apparatus generally includes a handle, and an elongated shank with opposing proximal and distal ends. The distal end supports a tool driver. The proximal end is pivotally coupled to a location offset from a midline of the handle to facilitate alignment of the shank along the handle in pivotally opposite extended and shortened positions, respectively.

In the extended position, the tool driver projects a first distance beyond a first end of the handle. In the shortened position, the tool driver projects beyond an opposing second end of the handle a second distance less than the first distance.

### BRIEF DESCRIPTION OF THE DRAWINGS

FIGS. 1A and 1B provide respective elevational representations of a reversible tool assembly constructed in accordance with some embodiments of the present invention, with the tool assembly in an extended (first) orientation in FIG. 1A and in a shortened (second) orientation in FIG. 1B.

FIG. 2 shows a cross-sectional representation of a handle portion of the tool assembly of FIGS. 1A-1B.

FIGS. 3A-3B provide side representations of the tool assembly of FIGS. 1A-1B.

FIG. 4 generally illustrates the tool assembly in an intermediate (t-bar) configuration.

FIG. 5 provides an alternative embodiment of a proximal end of a shank portion of the tool assembly with side projections affixed to the shank portion.

FIGS. 6A-6C provide respective elevational representations of another reversible tool assembly in accordance with various embodiments of the present invention.

FIG. 7 is an exploded representation of the tool assembly of FIGS. 6A-6C.

FIG. 8 provides an end cross-sectional depiction of a handle of the tool assembly of FIG. 7.

FIG. 10 provides a side cross-sectional depiction of the handle of FIG. 7.

FIG. 11 generally illustrates an alternative tool driver configuration for the tool assembly that utilizes removable bits.

FIG. 12 provides another tool driver with a removable socket driver configuration.

FIG. 13 depicts another tool driver that employs a flat screwdriver configuration.

FIG. 14 shows yet another tool driver that employs a hex key wrench configuration.

### DETAILED DESCRIPTION

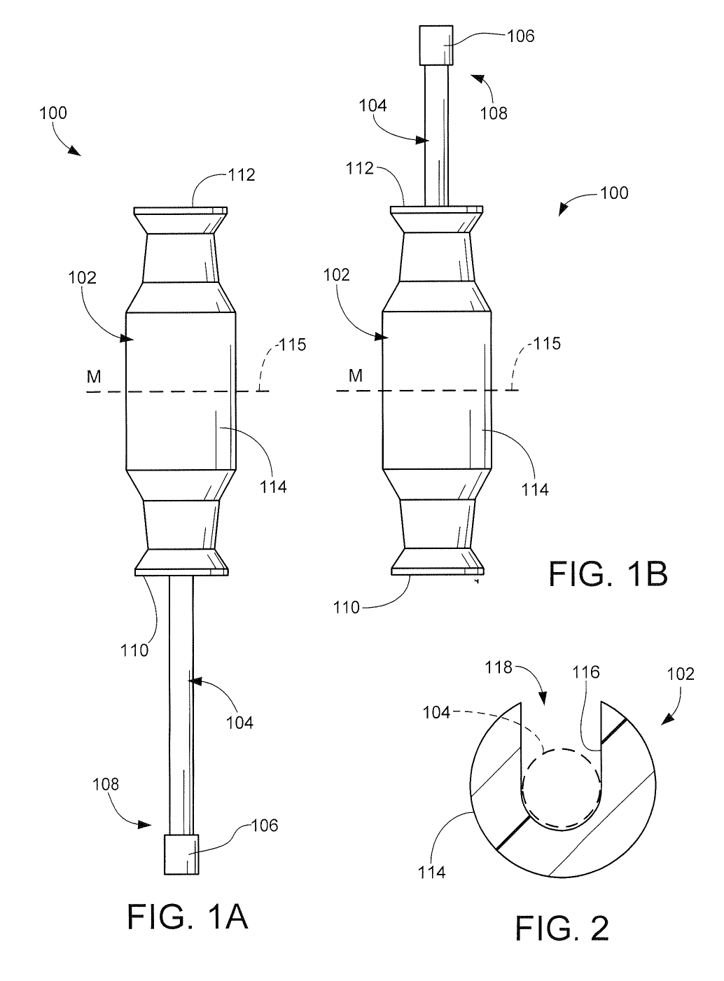

FIGS. 1A and 1B generally depict an exemplary reversible tool assembly 100 constructed in accordance with various embodiments of the present invention. The assembly 100 includes a handle 102 and a pivotal shank 104. The shank 104 supports a tool driver 106 at a distal end 108 thereof.

The shank 104 is pivotally coupled to the handle 102 such that the tool assembly 100 can be alternatively placed in an extended position (FIG. 1A) or a shortened position (FIG. 1B). In the extended position, the tool driver 106 extends a first (normal) distance beyond a first end 110 of the handle 102. In the shortened position, the tool driver 106 extends a second (shortened) distance beyond a second end 112 of the handle 102 less than the first distance.

The handle 102 is preferably provisioned with an outer surface 114 sized and shaped to accommodate a human hand. An external layer of rubber or other elastomeric material can be applied as desired to enhance comfort and grip. The exemplary handle 102 is shown to be nominally symmetric about a midline 115 (centerline) of the handle 102, although such is not necessarily required.

For reference, the midline 115 is an imaginary line perpendicular to, and which bisects, the length of the handle 102 at the halfway point between the opposing handle ends 110, 112, so that the distance from the midline 115 to the first end 110 is the same as the distance from the midline 115 to the second end 112. The midline 115 may or may not intersect the center of gravity of the handle 102.

As shown in the cross-sectional view of FIG. 2, the handle 102 preferably incorporates an interior sidewall 116 that forms a central channel 118 along a length of the handle. The central channel 118 preferably has a substantially u-shaped cross-sectional shape as shown, and is sized to respectively accommodate placement of the shank 104 along the channel 118 in both the extended and shortened positions.

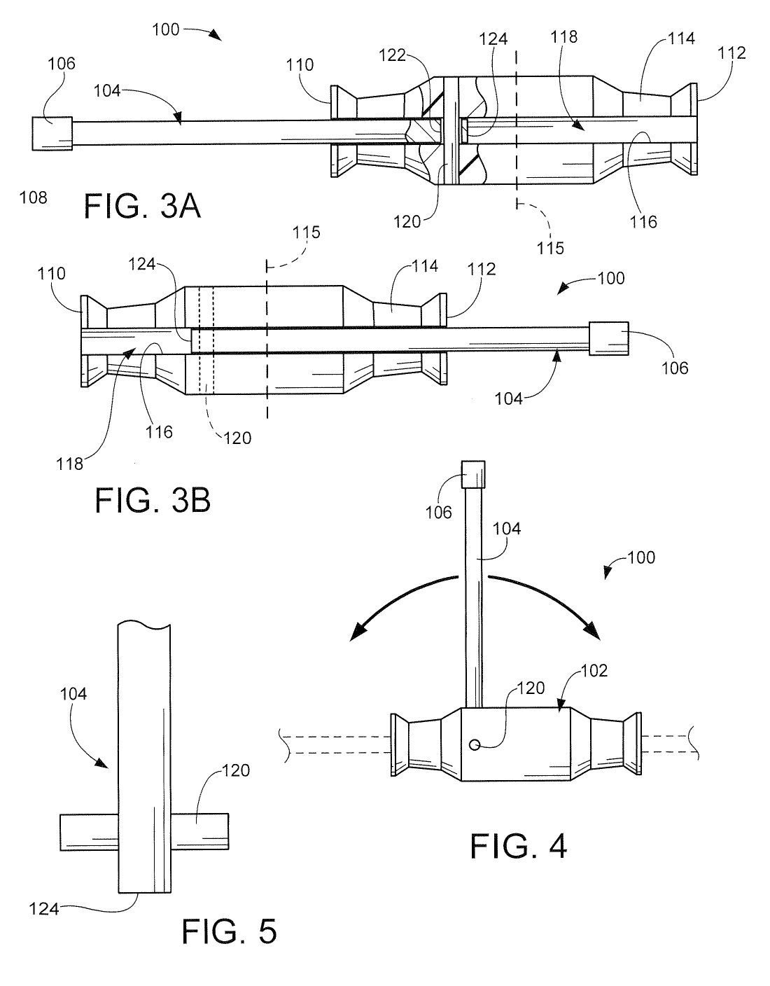

FIGS. 3A and 3B depict a laterally extending pivot pin 120 of the tool assembly 100. The pivot pin 120 extends across the channel 118 from opposing sides of the handle 102 and passes through an aperture 122 in a proximal end 124 of the shank 104. The pivot pin 120 facilitates rotational movement of the shank 104 between the extended and shortened positions, as generally represented in FIG. 4. It will be noted that the tool assembly 100 can be used in the in the intermediate t-bar configuration depicted in FIG. 4 as well.

The pivot pin 120 rotationally couples the proximal end 124 of the shank 104 to the handle 102 at a location along the handle 102 that is offset from the midline 115. In the present example, the pivot pin 120 is located between the midline 115 and the first end 110 of the handle 102. The resulting difference in projection length of the tool driver 106 from the handle 102 in the extended position as compared to the shortened position will be determined in relation to the distance separating the pivot pin 120 and the midline 115. A greater difference in tool driver extension length will be achieved as the pivot pin 120 is moved further away from the midline 115.

While the pivot pin 120 as shown in FIGS. 3-4 is a preferred coupling mechanism for the handle 102 and the shank 104, any number of other suitable arrangements can be employed as desired. In some embodiments, the pin 120 remains stationary with respect to the handle 102 such as, for example, by being press-fit or molded into the handle material. In such case, the aperture 122 in the distal end 124 of the shank 104 is sized to be slightly larger than the outermost diameter of the pin 120, and the shank 104 freely rotates about the stationary pin.

In an alternative embodiment, the pin 120 is permanently affixed to the distal end 122 of the shank 104 to provide opposing projections, such as generally depicted in FIG. 5. The projections rotate with the shank 104 within appropriate recesses, bushings, etc. in the handle 102. Bearings or other mechanisms can also be utilized as desired to accommodate the relative rotation of the shank 104 with respect to the handle 102.

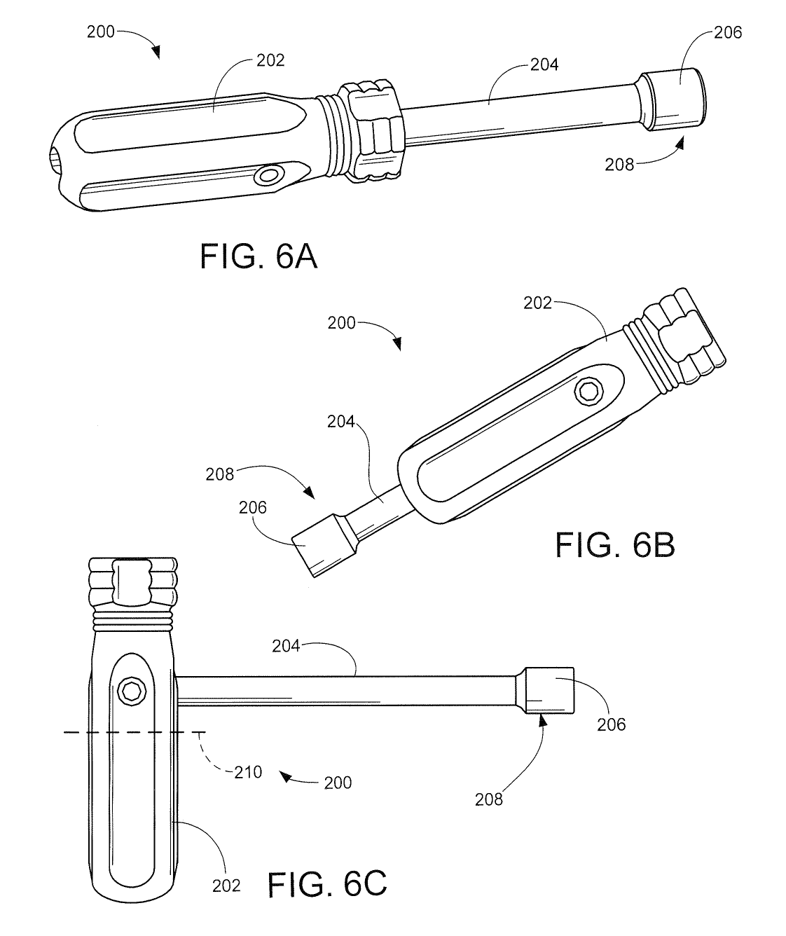

FIGS. 6A-6C show an alternative reversible tool assembly 200. As before, the tool assembly 200 generally comprises a handle 202 and a pivotally moveable shank 204. The shank supports a tool driver 206 at a distal end 208. FIG. 6A shows the tool assembly 200 in an extended position, FIG. 6B shows the tool assembly 200 in a shortened position, and FIG. 6C shows the tool assembly 200 in an intermediate (t-bar) configuration. Unlike the handle 102 in FIGS. 1-5, the handle 202 in FIGS. 6A-6C is non-symmetric about a midline 210 (FIG. 6C) and takes a more conventional hand-tool shape.

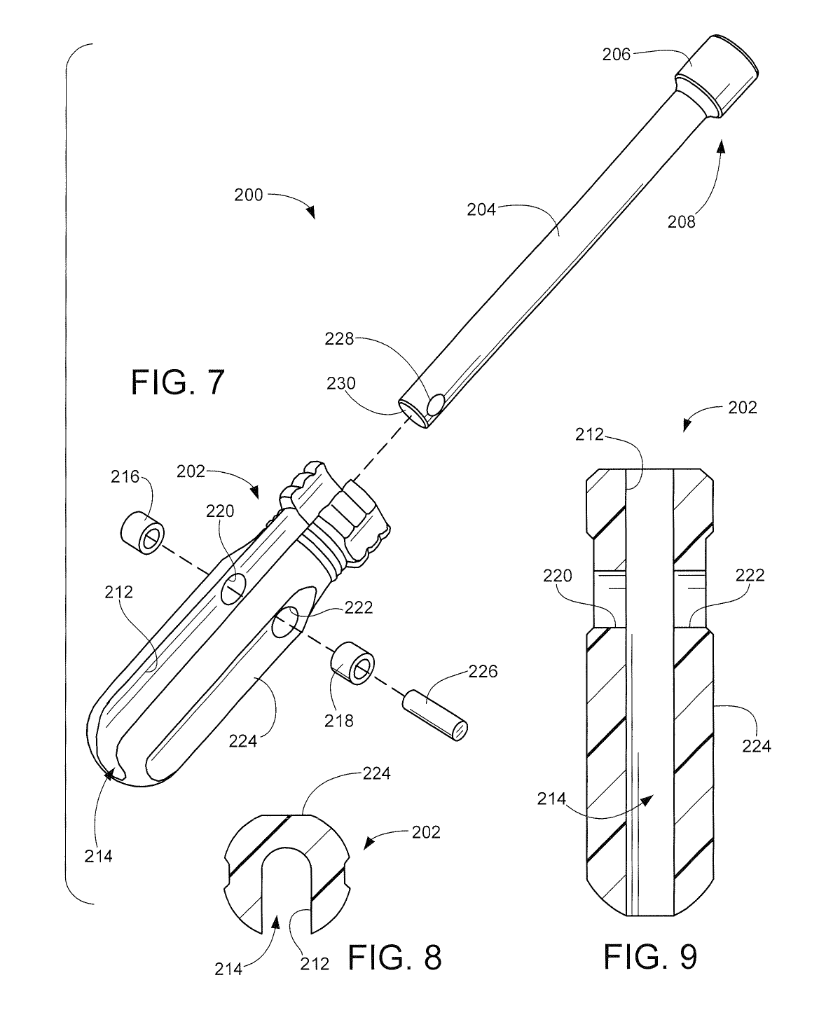

An exploded view of the tool assembly 200 is provided in FIG. 7. The handle 202 is shown to include an interior sidewall 212 that forms an axially extending central channel 214 to accommodate the shank 204. The tool assembly 200 further includes a pair of opposing bushing sleeves 216, 218 which are inserted into corresponding apertures 220, 222 in the handle 202. The apertures 220, 222 extend from an outermost surface 224 of the handle 202 to the interior sidewall 212 of the handle 202.

A pivot pin 226 engages the sleeves 216, 218 to capture the shank 204. More particularly, the shank 204 is provisioned with an aperture 228 at a distal end 230 of the shank 204, and the pin 226 passes through the aperture 228 to facilitate pivotal movement of the shank 204.

FIG. 8 shows the interior sidewall 212 to provide the channel 214 with a substantially u-shaped cross-sectional shape, as before. Further aspects of the handle 202 are shown in FIG. 9.

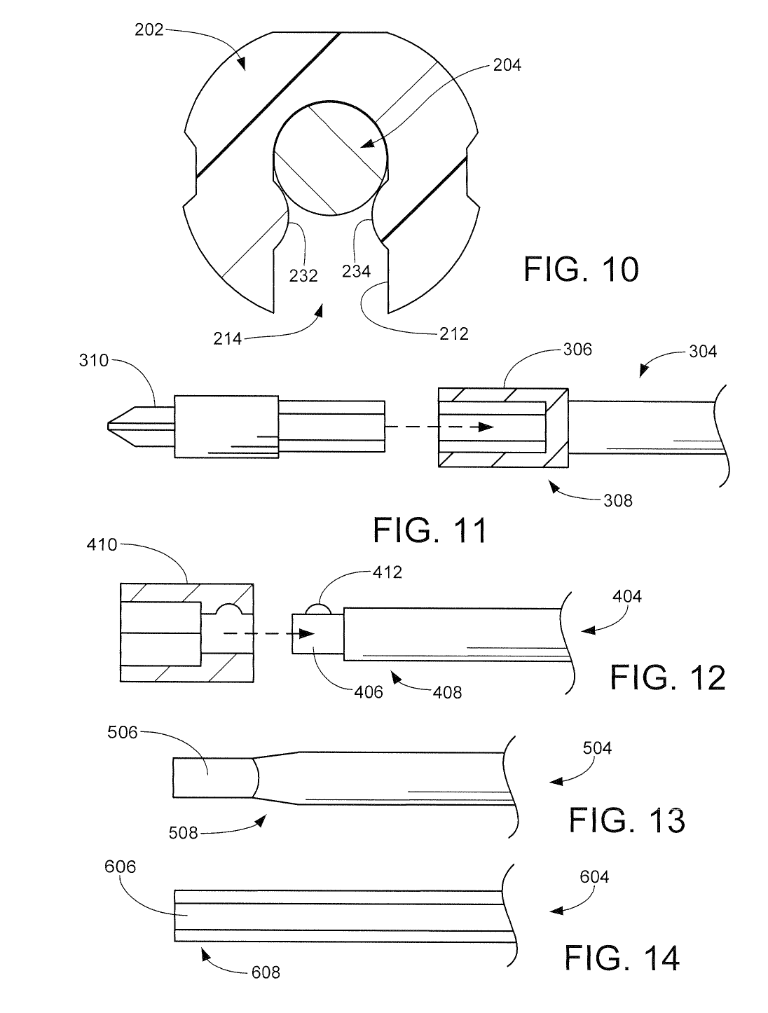

As desired, retention features such as detents 232, 234 in FIG. 10 can be provided to lockingly retain the shank 204 within the channel when the shank 204 is placed in the respective extended and shortened positions. The retention features are preferably sized and shaped to allow a small localized deformation of the interior sidewall 212 sufficient to lock (snap) the shank 204 into place. It is contemplated that one pair of the detents 232, 234 can be provided on each side of the pivot pin 226 so that the detents operate to respectively retain the shank 204 in each of the extended and shortened positions. A slight rotational force can be applied to the shank 204 by the user to release the shank 204 and move the tool assembly to the intermediate position (FIG. 6C).

While the above exemplary embodiments use a permanently attached socket driver as the disclosed tool driver, such is not necessarily limiting. FIG. 11 shows a shank 304 which supports a bit receptacle 306 at a distal end 308 of the shank 304. The receptacle 306 receivingly supports removable driver bits, such as the cross-head screwdriver bit denoted at 310. The bit 310 is slidingly inserted into the receptacle 306 and may be retained therein through the use of friction, detents, a magnetic plate, etc. The receptacle 306 advantageously enables the same tool assembly to accommodate any number of differently configured bits for different styles of operation.

Similarly, FIG. 12 shows a cylindrical shank 404 with a conventional quarter-inch, square socket engagement mechanism 406 projecting from a distal end 408 of the shank 404. The socket engagement mechanism 404 is configured to receivingly engage conventional sockets, such as the exemplary socket 410 (shown in cross-section). A deflectable detent ball 412 can be used to lock the sockets into place.

FIG. 13 shows another shank 504 with a flat screwdriver configuration 506 at a distal end 508. FIG. 14 provides yet another alternative shank 604 with a hex key wrench tool driver 606 at a distal end 608 thereof. Unlike the substantially cylindrical shanks shown above, the shank 604 in FIG. 14 has a hex (six-sided) configuration along its overall length, as shown.

Various other tool driver configurations can also be employed, including but not limited to an ice pick, a cutting blade, a hammer head, a saw, a drill bit, a chisel, etc. Moreover, the tool assembly is not necessarily limited to hand actuation, but rather can be additionally or alternatively configured for engagement with and operation by a power tool, such as a portable power drill.

It will be appreciated that the various embodiments presented herein provide important improvements over the art. The exemplary tool assemblies 100, 200 provide a highly effective tool driver configuration with easily adjusted overall lengths while retaining a conventional “hand tool” axial alignment of the handle during operation in the extended and shortened positions. The tool assemblies can be provided individually or in a set with different sizes, shapes and lengths of shanks, handles and/or tool drivers.

For purposes of the appended claims, the term “midline” will be construed consistent with the foregoing discussion to describe the midway line transverse to the axial length of the handle that bisects the handle into two equidistant segments.

It is to be understood that even though numerous characteristics and advantages of various embodiments of the present invention have been set forth in the foregoing description, this detailed description is illustrative only, and changes may be made in detail, especially in matters of structure and arrangements of parts within the principles disclosed herein to the full extent indicated by the broad general meaning of the terms in which the appended claims are expressed.

What is claimed is:

1. An apparatus comprising a handle and an elongated shank comprising opposing proximal and distal ends, the distal end supporting a tool driver, the proximal end pivotally coupled to a location offset from a midline of the handle to facilitate alignment of the shank along the handle in pivotally opposite extended and shortened positions, respectively, wherein the extended position is characterized as the tool driver projecting a first distance beyond a first end of the handle, and wherein the shortened position is characterized as the tool driver projecting beyond an opposing second end of the handle a second distance less than the first distance.

2. The apparatus of claim 1, wherein the handle comprises an outer surface configured to be gripped by a user and a central channel formed by an interior sidewall that depends from the outer surface, wherein the shank extends along the channel in the extended and shortened positions, respectively.

3. The apparatus of claim 2, wherein the central channel has a substantially u-shaped cross-section which is open to the surrounding atmosphere along an overall length of the handle.

4. The apparatus of claim 2, wherein the sidewall comprises a retention feature to retain the shank within the channel when the shank is disposed in the respective extended and shortened positions.

5. The apparatus of claim 1, wherein the shank extends through the first end of the handle when the shank is in the extended position, and wherein the shank extends through the second end of the handle when the shank is in the shortened position.

6. The apparatus of claim 1, wherein the tool driver is removable from the distal end.

7. The apparatus of claim 1, wherein the tool driver comprises a socket driver.

8. The apparatus of claim 1, wherein the tool driver comprises a hex key wrench.

9. The apparatus of claim 1, wherein the tool driver comprises a screwdriver.

10. The apparatus of claim 1, further comprising a pivot pin which extends from a first side of the handle, through the distal end of the shank to an opposing second side of the handle, and wherein the proximal end rotates about the pivot pin.

11. An apparatus comprising a handle and first means for pivotally presenting a tool driver alternately rotatable by said handle a first distance from a first end of the handle and a reduced second distance from an opposing second end of the handle.

12. The apparatus of claim 11, wherein the first means comprises an elongated shank comprising opposing proximal and distal ends, the tool driver affixed to the distal end, the proximal end pivotally coupled to a location offset from a midline of the handle to facilitate alignment of the shank along the handle in pivotally opposite, extended and shortened positions, the extended position characterized as the distal end projecting a first distance beyond a first end of the handle, the shortened position characterized as the distal end projecting beyond an opposing second end of the handle a second distance less than the first distance.

13. The apparatus of claim 11, wherein the first means comprises an elongated shank comprising a proximal end affixed to the handle via a pivot pin and a distal end supporting the tool driver.

14. The apparatus of claim 13, wherein the handle further comprises a central channel into which the shank respectively extends as the shank is pivoted about the pivot pin.

15. An apparatus comprising:
a handle comprising an outer surface configured to be gripped by a user and a central channel formed by an interior sidewall that depends from the outer surface and which axially extends along a length of the handle; and
an elongated shank comprising a proximal end rotatably coupled to the sidewall offset from a midline of the handle along said length, and a distal end which supports a tool driver, the shank configured to alternately extend along and within the channel in opposing first and second directions to present the tool driver at different effective distances from the handle.

16. The apparatus of claim 15, wherein the central channel has a substantially u-shaped cross-section to receivingly nest the shank.

17. The apparatus of claim 15, wherein the sidewall comprises a retention feature to retain the shank within the channel when the shank is disposed in the respective first and second directions.

18. The apparatus of claim 15, wherein the shank extends through a first end of the handle when the shank is in an extended position, and wherein the shank extends through a second end of the handle when the shank is in a shortened position.

19. The apparatus of claim 15, wherein the tool driver is removably coupled to the distal end of the shank.

20. The apparatus of claim 15, wherein the tool driver consists of one of the following: a socket driver, a hex key wrench, or a screwdriver.
